(19) United States
(12) Patent Application Publication
(10) Pub. No.: US 2019/0122224 A1
(43) Pub. Date: Apr. 25, 2019

(54) RECORDING MEDIUM FOR RECORDING CONTACT SUPPORT PROGRAM, CONTACT SUPPORT METHOD, AND INFORMATION PROCESSING APPARATUS

(71) Applicant: FUJITSU LIMITED, Kawasaki-shi (JP)

(72) Inventor: WEI ZHU, Edogawa (JP)

(73) Assignee: FUJITSU LIMITED, Kawasaki-shi (JP)

(21) Appl. No.: 16/148,422

(22) Filed: Oct. 1, 2018

(30) Foreign Application Priority Data
Oct. 25, 2017 (JP) 2017-206451

(51) Int. Cl. G06Q 30/00

(52) U.S. Cl. CPC G06Q 30/01

(57) ABSTRACT

A non-transitory computer-readable recording medium recording a contact support program causing a computer to execute a process, the process includes receiving an input of information to identify a person to contact for a first user, performing at least one of referring to a storage that stores relationships between persons, between companies, or between persons and companies and collecting information on the relationships between the persons, between the companies, or between the persons and the companies from a network, identifying a path which leads from the first user to the person to contact through a chain of persons having a relationship or a chain of mixed persons and companies having a relationship, and outputting information on the identified path.

### CROSS-REFERENCE TO RELATED APPLICATION

This application is based upon and claims the benefit of priority of the prior Japanese Patent Application No. 2017-206451, filed on Oct. 25, 2017, the entire contents of which are incorporated herein by reference.

### FIELD

Examples discussed herein are related to a recording medium for recording a contact support program, a contact support method, and an information processing apparatus.

### BACKGROUND

Companies are engaged in sales operations to acquire new customers.

Related technologies are disclosed in Japanese Laid-open Patent Publication No. 2005-108123 or Japanese Laid-open Patent Publication No. 2015-125736.

### SUMMARY

According to an aspect of the embodiments, a non-transitory computer-readable recording medium recording a contact support program causing a computer to execute a process, the process includes: receiving an input of information to identify a person to contact for a first user; performing at least one of referring to a storage that stores relationships between persons, between companies, or between persons and companies and collecting information on the relationships between the persons, between the companies, or between the persons and the companies from a network; identifying a path which leads from the first user to the person to contact through a chain of persons having a relationship or a chain of mixed persons and companies having a relationship; and outputting information on the identified path.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates an exemplary contact support system;

FIG. 2 illustrates an exemplary server device;

FIG. 3 illustrates exemplary relation information;

FIG. 4 illustrates an exemplary data structure of a relation master;

FIG. 5 illustrates an exemplary new information alert screen;

FIG. 6A illustrates an exemplary correlation screen;

FIG. 6B illustrates an exemplary correlation screen;

FIG. 7A illustrates a search for a path;

FIG. 7B illustrates a search for a path;

FIG. 8A illustrates an exemplary path display screen;

FIG. 8B illustrates an exemplary path display screen;

FIG. 9 illustrates exemplary contact support processing; and

FIG. 10 illustrates an exemplary computer that executes a contact support program.

### DESCRIPTION OF EMBODIMENTS

For example, in an insurance company, salespersons in charge of corporations approach persons who are key people of companies as contact targets.

For example, when salespersons are not acquainted with contact targets, the salespersons may have difficulty in approaching the contact targets.

For example, a contact support program or the like that may support an effective approach to contact targets may be provided.

### Example 1

System Configuration

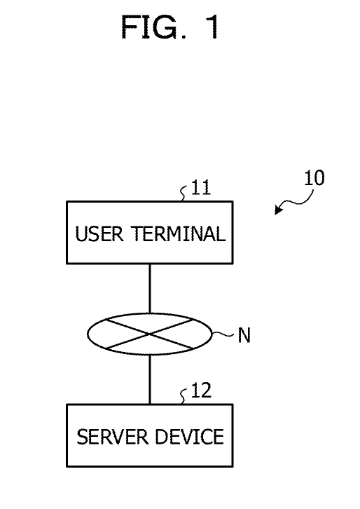

FIG. 1 illustrates an exemplary contact support system. As illustrated in FIG. 1, a contact support system 10 includes a user terminal 11 and a server device 12. In the present example, the server device 12 corresponds to a contact support device.

The contact support system 10 is a system for supporting sales operations of salespersons. Salespersons perform various sales operations in order to acquire new customers. In the present example, a case of supporting the sales operations of the salespersons in charge of corporations in an insurance company for companies will be described as an example. Generally, in the case of newly developing customers, salespersons collect information on companies. Based on the collected information, the salespersons determine the companies to contact. Salespersons make contacts such as phone calls or visits to the companies to contact. The contact support system 10 supports contact with a company to contact.

A user terminal 11 is communicably coupled to the server device 12 via a network N. As one aspect of such the network N, any type of communication networks such as local area network (LAN), virtual private network (VPN), mobile communication network and the like may be adopted regardless of wired or wireless.

The user terminal 11 is a device possessed by a salesperson who is a user. For example, the user terminal 11 is a portable terminal device such as a smartphone or a tablet terminal. The salesperson accesses the server device 12 by using the user terminal 11 and performs sales activities for acquiring new customers.

The server device 12 is a computer that provides the user with a contact support service that supports contact. The contact support service may be provided by one computer or may be provided by a computer system with a plurality of computers. In the present example, a case where the contact support service is provided by one server device 12 will be described as an example.

Server Device

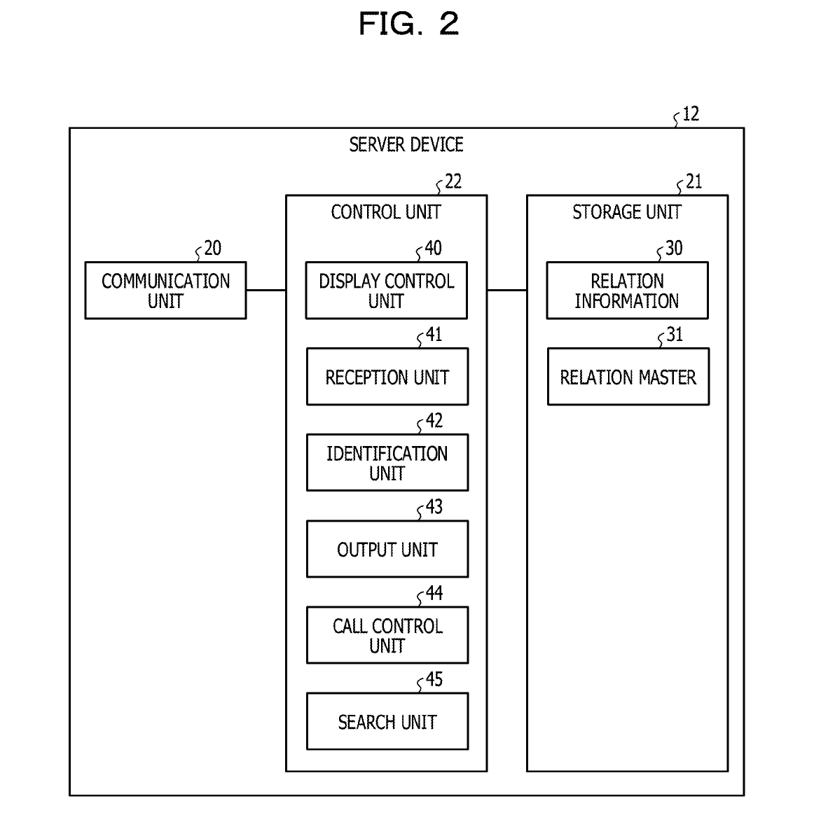

FIG. 2 illustrates an exemplary configuration of the server device. As illustrated in FIG. 2, the server device 12 includes a communication unit 20, a storage unit 21, and a control unit 22.

The communication unit 20 is an interface for performing communication control with other devices. The communication unit 20 transmits and receives various information to and from other devices via the network N. As the communication unit 20, a network interface card such as a LAN card may be adopted.

The storage unit 21 is a storage device such as a hard disk, a solid state drive (SSD), an optical disk, or the like. The storage unit 21 may be a semiconductor memory capable of rewriting data such as random access memory (RAM), flash memory, non-volatile static random access memory (NVSRAM) or the like. The storage unit 21 may be an external server that stores and provides data.

The storage unit 21 stores various programs including a program for executing contact support processing to be described later. The storage unit 21 stores various data used in various programs. For example, the storage unit 21 stores relation information 30 and a relation master 31.

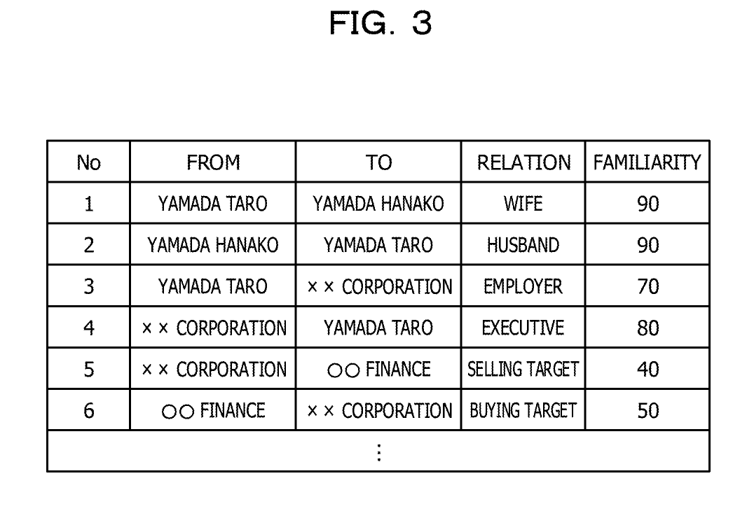

The relation information 30 is data that stores information on relationships between objects, such as companies and persons. FIG. 3 illustrates exemplary relation information. In the present example, information on relationships between persons, relationships between companies, and relationships between persons and companies are stored in the relation information 30. As illustrated in FIG. 3, the relation information 30 has items such as “No”, “From”, “To”, “relation”, “familiarity”, and the like. Each item of the relation information 30 illustrated in FIG. 3 is an example, and other items may be included.

The item of No is an area for storing a serial number assigned to the relationships between the objects. The relationships between the objects are numbered in order. In the item of No, the number assigned to the relationships between the objects is stored.

The item of From is an area for storing information on an object such as a company or a person as a relation source of the relationship.

The item of To is an area for storing information on an object such as a company or a person as a relation target of the relationship.

The item of relation is an area for storing information on the relation from From to To. The item of familiarity is an area for storing the familiarity of the relation from From to To. Familiarity is an index indicating the goodness of the relation from the object of From to the object of To.

The familiarity is closer relation as the value the familiarity is larger, indicating that the influence from the object of From to the object of To is large and it is easy to introduce. Familiarity is an exemplary index indicating the strength of connections. For example, the example of FIG. 3 illustrates that the relationship of No “1” is that a relation source is “Yamada Taro” and a relation target is “Yamada Hanako”, a relation is “Wife”, and familiarity is “90”.

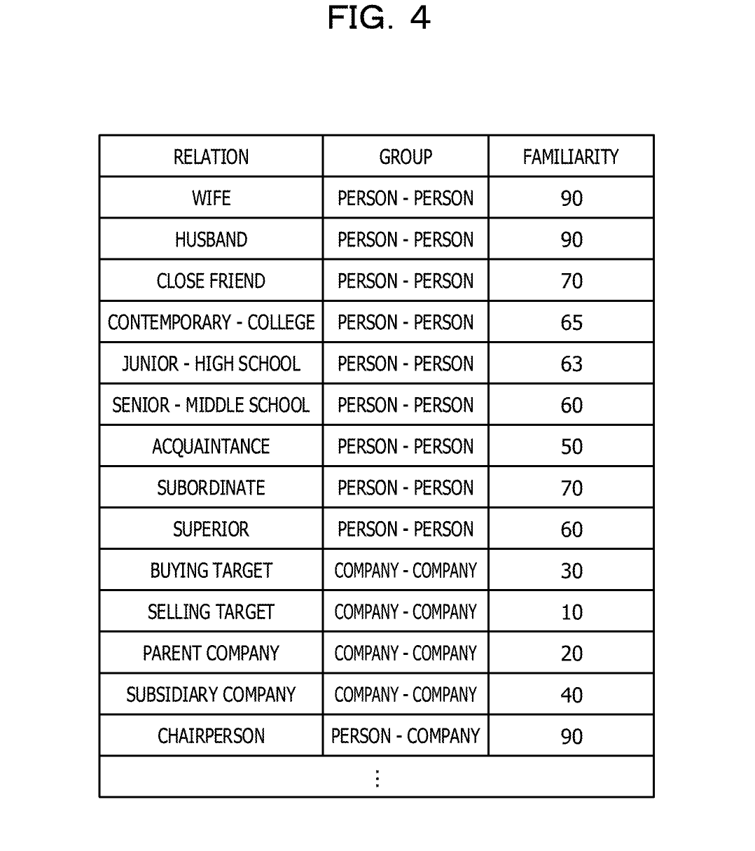

The relation master 31 is data that stores information on the standard familiarity of relationship. FIG. 4 illustrates an exemplary data structure of a relation master. As illustrated in FIG. 4, the relation master 31 has items such as “relation”, “group”, “familiarity”, and the like. Each item of the relation master 31 illustrated in FIG. 4 is an example, and other items may be included.

The item of relation is an area for storing the relationships between the objects for which the familiarity is determined. In the present example, the relation master 31 stores standard familiarity of relationships between persons, relationships between companies, and relationships between persons and companies.

The item of group is an area for storing a type of relationship. In the present example, the relationships are classified into three types of “person-person” indicating a connection between persons, “company-company” indicating a connection between companies, and “person-company” indicating a connection between a person and a company.

The item of familiarity is an area for storing the standard familiarity of relationships. For example, in the example of FIG. 4, the relation “wife” is a connection between persons and the standard familiarity is 90.

The control unit 22 is a device that controls the server device 12. As the control unit 22, electronic circuits such as a central processing unit (CPU), a micro processing unit (MPU) and the like, or integrated circuits such as an application specific integrated circuit (ASIC) and a field programmable gate array (FPGA) may be adopted. The control unit 22 has an internal memory for storing programs defining various processing procedures and control data, and executes various processing thereby. The control unit 22 causes various programs to operate and functions as various processing units. For example, the control unit 22 includes a display control unit 40, a reception unit 41, an identification unit 42, an output unit 43, a call control unit 44, and a search unit 45.

The display control unit 40 controls the display of various kinds of information. For example, when receiving an access from the user terminal 11, the display control unit 40 transmits information of various operation screens to the accessing user terminal 11 and performs control to display the operation screens on the accessing user terminal 11. For example, in response to the access from the user terminal 11, the display control unit 40 causes the user terminal 11 to display a login screen for a user ID to be input and receives a login

The salesperson operates the user terminal 11, inputs the user ID assigned in advance to the login screen and logs in. Upon successful login, the display control unit 40 performs control to display various screens such as an operation screen on the user terminal 11. For example, the display control unit 40 causes the user terminal 11 to display a new information alert screen 100 displaying predetermined types of information to be noticed by the logged-in user. For example, the display control unit 40 displays information to be noticed in the sales operations, which has occurred in an area that the logged-in salesperson is in charge of, or in a company within the area handled by the business office to which the logged-in salesperson belongs, on the new information alert screen 100.

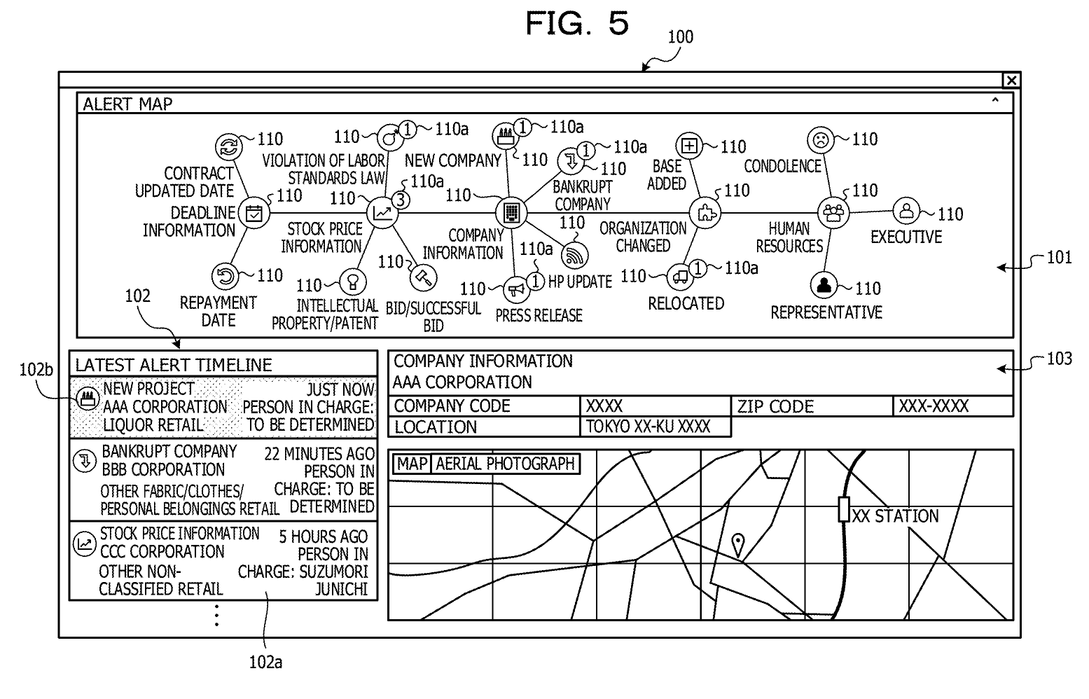

FIG. 5 illustrates an exemplary new information alert screen. The new information alert screen 100 includes an alert map display area 101, a timeline display area 102, and a company information display area 103.

In the alert map display area 101, an icon 110 is displayed for each type of information to be noticed, and icons 110 related to the type of information are connected with lines and the type of information is displayed in a map shape. For example, the icon 110 of “company information” is displayed with the icon 110 of “press release”, the icon 110 of “bankrupt company” and the icon 110 of “new company” connected with a line.

In the alert map display area 101, the number of information 110a to be noticed is displayed in association with the icon 110 for each type of information.

In the timeline display area 102, information to be noticed is displayed in the order of occurrence. In the example of FIG. 5, the type of information that has occurred and the name of the company as the source of the information are separated by a line and displayed in the order of occurrence. When any icon 110 in the alert map display area 101 is selected in the timeline display area 102, only information corresponding to the type of the selected icon 110 is displayed.

In the company information display area 103, various kinds of information on a company are displayed. When any line of the timeline display area 102 is selected, various kinds of information on the company as the source of the information of the selected line are displayed in the company information display area 103. In the example of FIG. 5, a company name, a company code, a zip code, a location, and a map indicating a position of the location is displayed.

Here, the salesperson is seeking information on companies to be sales targets.

Therefore, the server device 12 displays various kinds of information on the company on the new information alert screen 100, such as a new company, a relocated company, a company whose stock price has greatly changed, and the like. New companies are highly unlikely to be insured. For this reason, new companies are candidates for influential sales targets. As changes happen within the companies that have relocated, changes or review of insurance may occur. For this reason, relocated companies are candidates for influential sales targets.

Various kinds of information to be displayed on the new information alert screen 100 may be collected from various homepages by the server device 12, and may be obtained from a server of an information providing service provider that provides a service of providing various kinds of information on a company as appropriate and used. Examples of information providing service providers include Teikoku Databank and Tokyo Shoko Research.

From the various information displayed on the new information alert screen 100, the salesperson may grasp the candidates for sales target companies, such as a new company, a relocated company, a company whose stock price has greatly changed, and the like. The salesperson determines target companies to contact from the candidates for sales target companies and conducts sales activities.

By the way, the salesperson may have difficulty in approaching target companies if he or she is not acquainted with the target companies.

Therefore, for example, the display control unit 40 causes the user terminal 11 to display a correlation screen 120 indicating the correlation between companies in response to a predetermined operation by the user.

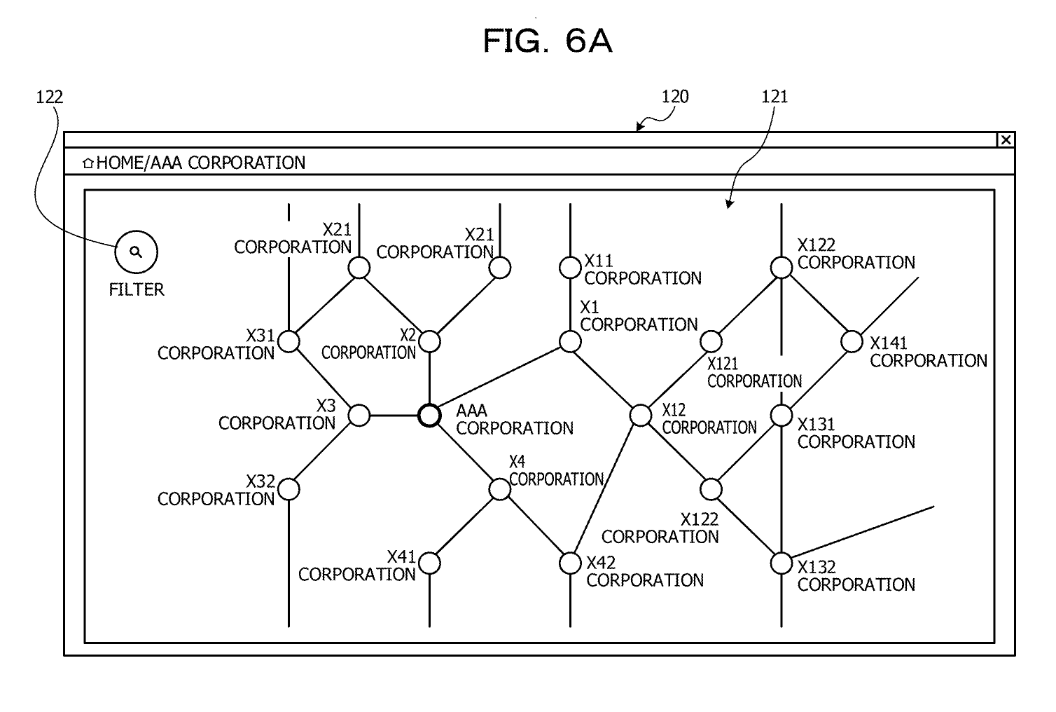

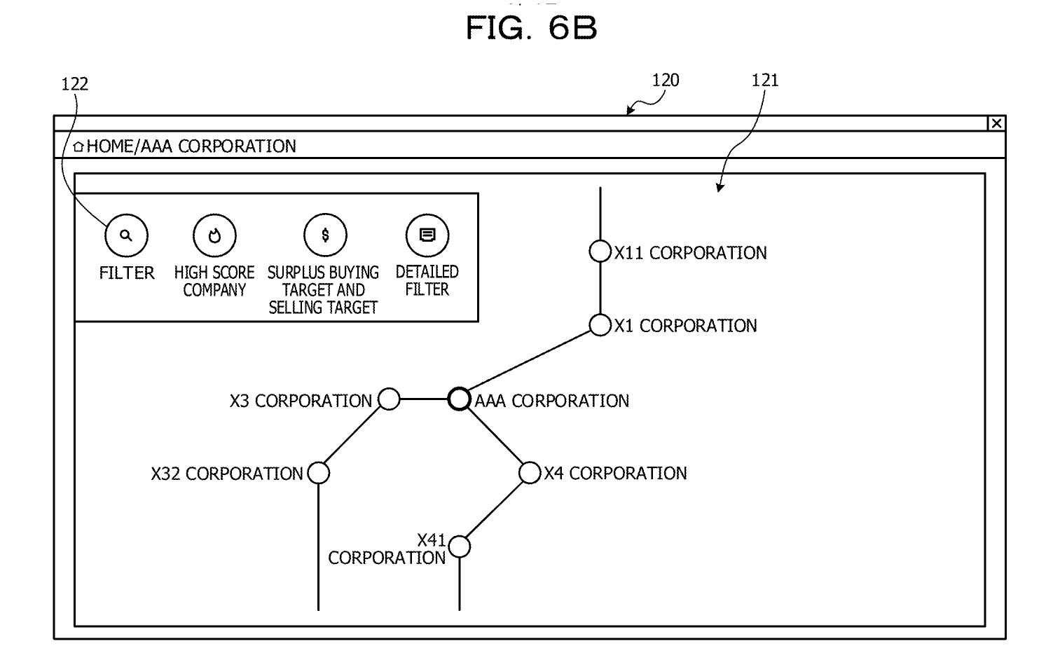

FIG. 6A illustrates an exemplary correlation screen. In the correlation screen 120, a correlation area 121 is provided.

In the correlation area 121, for each company, companies having a business relation such as a buying target, a selling target or the like, and companies having a relation such as an investment company, an investee company, and the like are illustrated by lines in association with each other. In the example of FIG. 6A, companies having a relation with the company of “AAA Corporation” are illustrated in association with each other. The correlation area 121 is provided with a filter icon 122 for displaying only companies having a specific relation. When the filter icon 122 is selected, the condition of the filter is displayed in the correlation area 121, and, when the condition is specified, the company that satisfies a specified condition is displayed. Filter conditions may be registered in advance.

FIG. 6B illustrates an exemplary correlation screen. In the correlation screen 120, a correlation area 121 is provided. In the example of FIG. 6B, when the filter icon 122 is selected, as pre-registered conditions, “high score company” and “surplus buying target and selling target”, and “detailed filter” individually specifying conditions are displayed. “high score company” is a condition for scoring a company's capital, sales proceeds, and the like to specify a display of a company whose score is equal to or more than a predetermined value. “surplus buying target and selling target” is a condition for specifying a display of a buying target company of a surplus and a selling target company of a surplus. In the example of FIG. 6B, “high score company” is specified, and the company having a score equal to or more than the predetermined value is displayed among the companies having a relation with the company “AAA Corporation”.

By the way, in sales activities, it is important to meet with key people who have the authority to decide on insurance within the target company and build a trust relation. Such key people are, for example, presidents and executives of companies. When the salesperson is not acquainted with key people, even if the salesperson calls or visits the target company, it often happens that he or she may not meet the key people. On the other hand, when the salesperson is introduced to the key people through a person who is already acquainted with the key people, the salesperson may meet the key people in many cases. In the case of being introduced to the key people through a person who is already acquainted with the key people, trust in the person acquainted with the key people is helpful, and it is easy to build a trust relation with the key people early.

Salespersons are not individually rich in personal networks. For this reason, salespersons are struggling to find persons who may introduce key people of target companies.

Therefore, in the contact support system 10 according to the present example, information on relationships between objects, such as various companies and persons, is registered and stored in the relation information 30. For example, the server device 12 receives information on personal networks of individuals and information on personal networks collected from each salesperson or each employee of a company to which each salesperson belongs, via the user terminal 11, and registers information on the relationships between companies or persons to the relation information 30. The server device 12 collects information such as company executives, capital, sales proceeds, business partners, shareholders (investors), investees, and the like from the server of the information providing service provider and registers information on relationships between companies and persons in the relation information 30. The server device 12 collects personnel information of a company and information on business partners or the like from information presented on media such as newspapers and registers information on relationships between companies and persons in the relation information 30. The server device 12 collects information such as personal network information and company information from open information searchable on the Internet such as information obtained from a social network service, and registers information on relationships between companies and persons in the relation information 30. As a social network service, for example, FaceBook and Twitter (registered trademark) may be used.

The server device 12 according to the present example obtains familiarity according to the relationship between each object registered in the relation information 30 based on the relation master 31, and registers the obtained familiarity in the relation information 30.

The familiarity to be registered in the relation information 30 may be corrected from the familiarity registered in the relation information 30. For example, familiarity may be corrected according to the degree of relationship between objects. For example, if the relationship is a relation of person-person and the persons are acquainted with each other, the familiarity is 50. For example, even if a person is an acquaintance, when the persons have similarities like the same college graduates, the same hobby, the same department, and the like, the familiarity may be corrected to 60 by adding 10 thereto. For example, even if a person is an acquaintance, when the persons have a private relation such as drinking companions, sports companions, and the like, the familiarity may be corrected to 70 by adding 20 thereto.

When the relationship is a relation of person-person, the familiarity to be registered in the relation information 30 may be corrected according to the power relation from the person of From to the person of To. For example, when a person of From has a weak power relation with a person of To, such as a junior or subordinate, 1 may be added to familiarity. When a person of From has an equal power relation with a person of To, such as joining a company at the same time, 5 may be added to familiarity. When a person of From has a strong power relation with a person of To, such as senior and superior, 9 may be added to familiarity. As a result, for example, a couple having an equal power relation is corrected to have the familiarity of 95 (=90+5). The superior of the same department is corrected to have the familiarity of 61 (=60+1). An acquaintance having an equal power relation is corrected to have the familiarity of 55 (=50+5). In this case, the order in which an introduction is easier will be a couple with an equal power relation, a superior in the same department, and an acquaintance with an equal power relation in descending order of familiarity.

The connection between persons tends to have a stronger trust relation than the connection between companies. For this reason, in the present example, in the relation master 31, it is defined such that the connection between a company and a person has higher standard familiarity than the connection between companies and the connection between persons has much higher standard familiarity than the connection between a company and a person. For example, a company sets the familiarity of 10 for selling targets excluding the parent company thereof, the familiarity of 20 for the parent company, the familiarity of 30 for buying targets excluding subsidiaries, and the familiarity of 40 for the subsidiaries.

The reception unit 41 receives various operations. For example, the reception unit 41 receives various kinds of operation information on the operation screen and receives various operations from the user terminal 11. The display control unit 40 controls the display of the screen according to the various operations received by the reception unit 41. For example, the display control unit 40 displays information on the executives of the company collected from the server of an information providing service provider on the screen according to the various operations received by the reception unit 41. The reception unit 41 receives an input of information for identifying a person to contact for the logged-in user. For example, the reception unit 41 receives a specification of a person to contact among the executives of the company displayed on the screen. The salesperson operates the screen to specify a person to contact for the company to contact.

The identification unit 42 performs various kinds of identification. For example, the identification unit 42 refers to the relation information 30 stored in the storage unit 21 and identifies a path leading from the logged-in user to the specified person to contact. For example, the identification unit 42 traces the relationship between objects, such as a company or a person, stored in the relation information 30 by using a predetermined search algorithm and identifies a path (route) leading from the logged-in user to a person to contact. As the search algorithm, for example, the Dijkstra method, the best priority search, a genetic algorithm, and the like may be mentioned but is not limited thereto.

The identification unit 42 identifies a plurality of paths leading from the logged-in user to a person to contact. For example, the identification unit 42 identifies a path leading from a logged-in user to a person to contact through a chain of persons having a relationship and a chain of mixed persons and companies having a relationship. For example, the identification unit 42 identifies the “shortest path” leading from the logged-in user to the person to contact through the shortest chain. The identification unit 42 identifies a “strongly connected path” having the highest familiarity indicating the strength of the connection corresponding to the relationship included in each chain from the logged-in user to the person to contact. The identification unit 42 identifies a “path through a chain of persons only” that leads from the logged-in user to the person to contact through the chain of persons only.

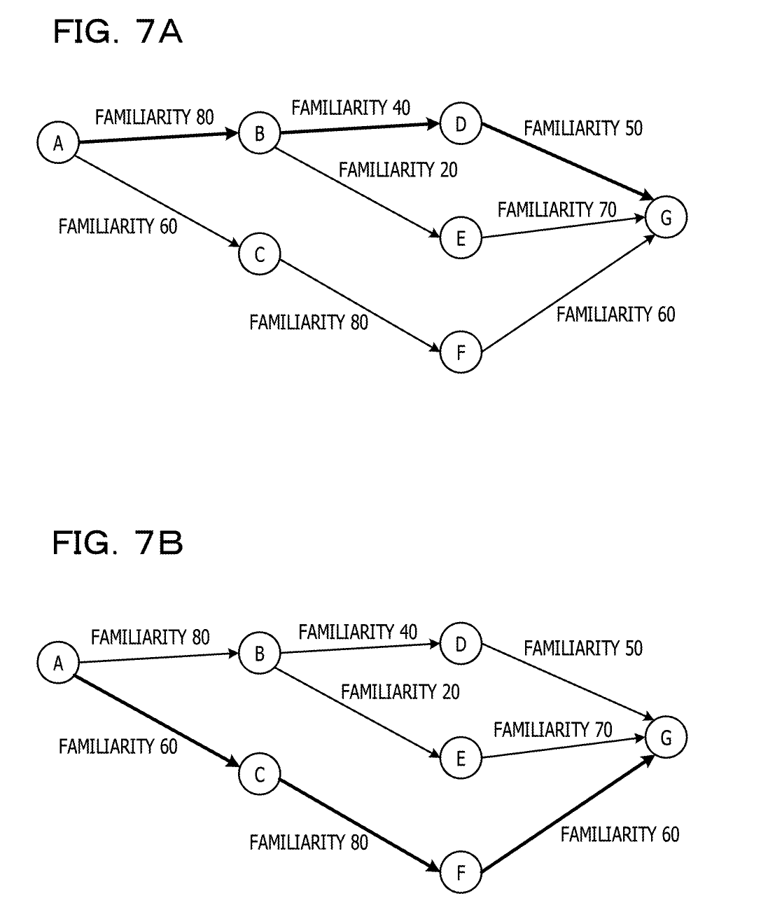

FIGS. 7A and 7B illustrate examples of path search. In FIGS. 7A and 7B, objects A to G indicating a company or a person are illustrated. In FIGS. 7A and 7B, when there is a relationship between persons, between companies, and between a person and a company among the companies or persons indicated by objects A to G, the objects are connected with lines, and the familiarity of the relationships are illustrated. In the example of FIGS. 7A and 7B, the object A has a relationship with the object B having the familiarity of 80 and has a relationship with the object C having the familiarity of 60. The object B has a relationship with the object D having the familiarity of 40 and has a relationship with the object E having the familiarity of 20. The object C has a relationship with the object F having the familiarity of 80. The object D has a relationship with the object G having the familiarity of 50. The object E has a relationship with the object G having the familiarity of 70. The object F has a relationship with the object G having the familiarity of 60. In the example of FIGS. 7A and 7B, it is assumed that the object A is a logged-in user and the object G is a person to contact.

For example, the identification unit 42 identifies the shortest path leading from the logged-in user to the person to contact through the shortest chain. For example, the identification unit 42 identifies the shortest path with the least number of chain relationships connected from the logged-in user to a person to contact. In the example of FIG. 7A, three shortest paths are identified, object A object B object D object G, object A object B object E object G, and object A object C object F object G. When there is a plurality of paths having the least number of chains, the identification unit 42 may identify a path with the least number of persons passing through as the shortest path. When there is a plurality of paths, the identification unit 42 may identify a path with the least number of companies passing through as the shortest path.

For example, the identification unit 42 identifies a strongly connected path having the highest familiarity indicating the strength of the connection corresponding to the relationship included in each chain from the logged-in user to the person to contact. That is, the identification unit 42 sequentially selects a connection with a higher familiarity from the logged-in user and identifies a partial optimum path leading to a person to contact. In the example of FIG. 7A, for object A, since object B has a higher familiarity than object C, object A object B is selected. For object B, since object D has a higher familiarity than object E, object B object D is selected. As illustrated in FIG. 7A, the path of the object A the object B the object D the object G is identified as a strongly connected path.

For example, the identification unit 42 identifies a path through a chain of persons only that leads from the logged-in user to the person to contact through a chain of persons only. For example, when the object B is a company, as illustrated in FIG. 7B, the path of the object A the object C the object F the object G is identified as the path through the chain of persons only.

By the way, even if the average familiarity of the chain of a path is high, an introduction may be refused when some familiarity is low. Therefore, the reception unit 41 may receive the condition of the path. For example, the reception unit 41 may receive a threshold value of familiarity for a path. The identification unit 42 may identify a path leading to a contact target through a chain whose familiarity is equal to or more than a specified threshold value.

The output unit 43 performs various outputs. The output unit 43 outputs information on the path identified by the identification unit 42. For example, the output unit 43 displays information on the path on the screen. For example, the output unit 43 connects the persons and companies constituting the path for each identified path and displays the path on the screen. For example, the output unit 43 displays the shortest path, a strongly connected path, and a path through a chain of persons only on the screen. For example, the output unit 43 displays the shortest path, the strongly connected path, and the path through a chain of persons only illustrated in FIGS. 7A and 7B on the screen to be distinguishable from each other. For easy visual perception, the output unit 43 changes the display mode according to the familiarity between the objects or whether the object is a person or a company. For example, the output unit 43 changes the thickness and the type of the line connecting the objects in accordance with the familiarity between the objects to perform display. The output unit 43 displays the person and the company in different colors. As a result, the salesperson may grasp the paths of various personal networks having a possibility of introducing a person to contact.

The reception unit 41 may receive specification as to which one of the shortest path, the strongly connected path, and the path through a chain of persons only is to be output preferentially. For example, the reception unit 41 may receive a selection of which one of the shortest path, the strongly connected path, and the path through a chain of persons only is to be output preferentially from the screen. In this case, the output unit 43 preferentially outputs the specified path out of the identified shortest path, the strongly connected path, and the path through a chain of persons only. For example, the output unit 43 preferentially displays the specified path on the upper part of the screen. As a result, the salesperson may grasp the path of the personal networks having a possibility of introducing a person to contact under the condition of the specified path.

The reception unit 41 may receive a specification for prioritizing the traveling time to a person to contact. For example, the reception unit 41 may receive a specification for prioritizing the time up to a person to contact from the screen. In this case, the output unit 43 preferentially outputs the shortest path. For example, the output unit 43 preferentially displays the shortest path on the upper part of the screen. As a result, the salesperson may grasp the paths of various personal networks having a possibility of introducing a person to contact in a short time.

The call control unit 44 controls a call. For example, a call application for an IP telephone or the like that allows a phone call via the Internet is installed on the server device 12. The user terminal 11 is coupled to a device for making a call such as a microphone and a speaker, or a headset. When any one of the contacts of the persons and companies constituting the path displayed on the screen is specified, the call control unit 44 controls the call application to make a call to the specified contact. When the call with the contact is established, the call control unit 44 starts a call with the other party. For example, the call control unit 44 obtains the voice data of the other party via the call application and transmits the voice data to the user terminal 11, and obtains the voice data of the calling side from the user terminal 11 and transmits the voice data to the other party. As a result, the salesperson may easily contact the persons and companies constituting the path.

The search unit 45 performs various kinds of searches. For example, the search unit 45 searches for a traveling route to a person or a company constituting the path displayed on the screen. For example, the search unit 45 transmits the information on a start point and an end point to an external server that provides a service for searching for routes and searches for a traveling route. The start point may be the local position of the user terminal 11 collected from the user terminal 11, may be a workplace when the position information of the workplace is stored in association with the logged-in user or may be specified by the user. The end point is set to the address of the specified person or company.

The output unit 43 outputs the search result by the search unit 45. For example, the output unit 43 displays the searched traveling route on the screen. As a result, the salesperson may grasp the traffic route for visiting the specified person or company.

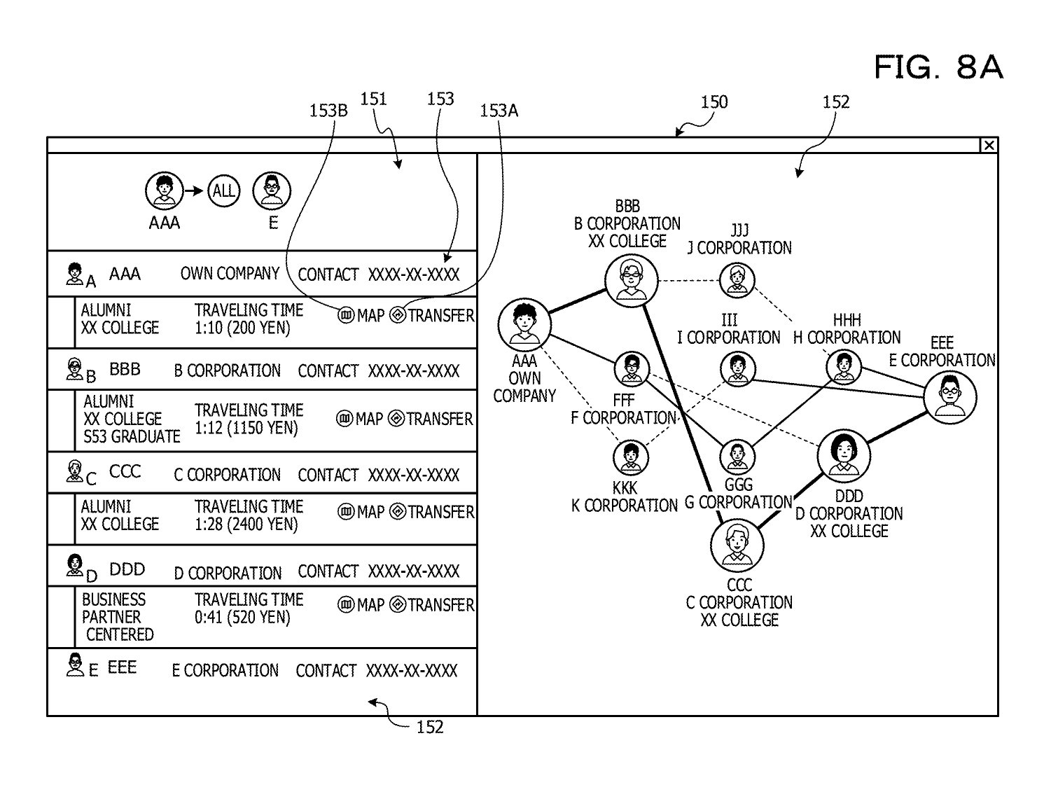

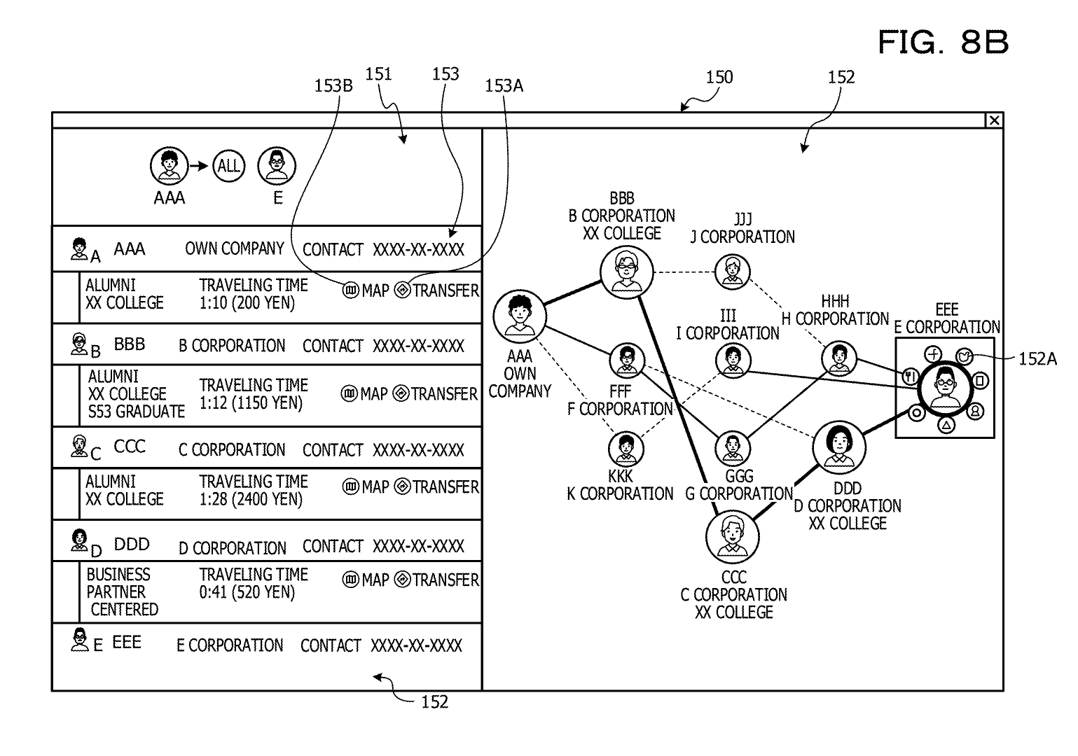

An exemplary path display screen on which the output unit 43 displays information on a path will be described. FIG. 8A illustrates an exemplary path display screen. The path display screen 150 includes a condition display area 151, a path display area 152, and a detailed display area 153.

In the condition display area 151, the condition of the path is displayed, and the logged-in user who is the source of the path and a person to contact are displayed. In FIG. 8A, “ALL” indicates that the path leading to the person to contact has been identified from the relationships between all the objects.

In the path display area 152, the persons and companies constituting the path are connected with lines and the identified path is displayed, and the type of the line is changed and displayed in accordance with the familiarity. In the path display area 152, a path may be specified.

The detail of the path specified in the path display area 152 is displayed in the detailed display area 153. In the example of FIG. 8A, the path of “AAA”→“BBB”→“CCC”→“DDD”→“EEE” is specified in the path display area 152, and the persons constituting the path and details of the relationship are displayed. In the example of FIG. 8A, the names of the persons and affiliated companies constituting the path and the contact information thereof are displayed. In the example of FIG. 8A, the relations between persons are displayed. In the example of FIG. 8A, the traveling time of the traffic route to the person constituting the path is displayed, the details of the traffic route are displayed when a transfer button 153A is selected, and the positions of the affiliated companies on the map is displayed when a map button 153B is selected.

The output unit 43 may be capable of displaying information such as information obtained from a social network service, open information searchable on the Internet, company information and the like for the persons and companies constituting the path. FIG. 8B illustrates an exemplary path display screen. For the person of “EEE” to contact, a link button 152A for displaying various kinds of information such as information obtained from social network services and company information is displayed, and corresponding information is displayed on a separate screen when the link button 152A is selected.

Flow of Processing

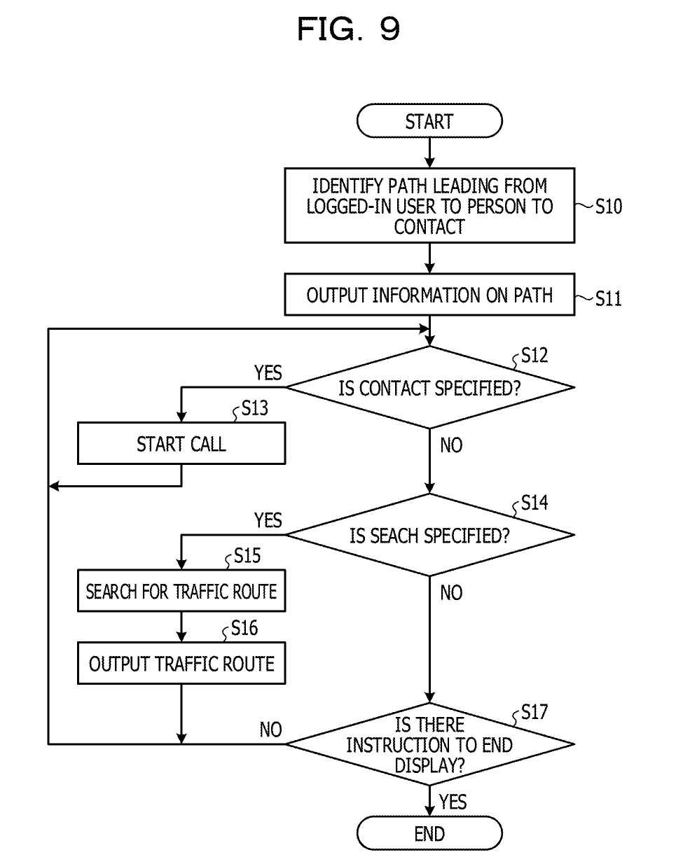

FIG. 9 illustrates exemplary contact support processing. The contact support processing illustrated in FIG. 9 is executed at a predetermined timing, for example, at a timing when the input of information for identifying a person to contact is received.

The identification unit 42 refers to the relation information 30 stored in the storage unit 21 and identifies a path leading from the logged-in user to the specified person to contact (S10). For example, the identification unit 42 identifies the shortest path leading from the logged-in user to the person to contact through the shortest chain. The identification unit 42 identifies a strongly connected path having the highest familiarity indicating the strength of the connection corresponding to the relationship included in each chain from the logged-in user to the person to contact. The identification unit 42 identifies a path through a chain of persons only that leads from the logged-in user to the person to contact through the chain of persons only.

The output unit 43 outputs information on the path identified by the identification unit 42 (S11). For example, the output unit 43 connects the persons and companies constituting the path for each identified path and displays the path on the screen. For example, the output unit 43 displays the shortest path, a strongly connected path, and a path through a chain of persons only on the screen.

The call control unit 44 determines whether a contact of any of the persons and companies constituting the path displayed on the screen is specified (S12). When a contact is specified (S12: Yes), the call control unit 44 controls the call application to make a call to the specified contact, starts a call with the other party (S13). After the call is finished, the process proceeds to S12.

On the other hand, when a contact is not specified (S12: No), the search unit 45 determines whether or not a search for a visiting route to the persons and companies constituting the path displayed on the screen is specified (S14). When a search is specified (S14: Yes), the search unit 45 searches for a traffic route to the specified person and company (S15). The output unit 43 displays the searched traffic route on the screen (S16) and the process proceeds to S12.

On the other hand, when a search is not specified (S14: No), the reception unit 41 determines whether or not a predetermined instruction to end the display is received (S17). In the case of receiving an instruction to end processing (S17: Yes), the display control unit 40 ends the display of the screen and ends the processing. On the other hand, when the instruction to end the display is not received (S17: No), the process proceeds to S12 described above.

Effect

As described above, the server device 12 according to the example receives an input of information for identifying a person to contact for a first user. The server device 12 refers to the storage unit 21 that stores relationships between persons and identifies a path leading from the first user to a person to contact through a chain of persons having a relationship. The server device 12 outputs information on the identified path. As a result, the salesperson may grasp the path leading to a person to contact from the information on the output path. As a result, the server device 12 may support an effective approach to contact targets.

The server device 12 according to the example receives an input of information for identifying a person to contact for the first user. The server device 12 refers to the storage unit 21 that stores relationships between persons, between companies, between persons and companies and identifies a path leading from the first user to a person to contact through a chain of persons having a relationship or through a chain of mixed persons and companies having a relationship. The server device 12 outputs information on the identified path. As a result, the salesperson may grasp the path leading to a person to contact from the information on the output path. As a result, the server device 12 may support an effective approach to contact targets.

For the relationship information stored in the storage unit 21, an index (familiarity) indicating the strength of the connection corresponding to the relationship is stored. The server device 12 receives an input of specification as to which one of the shortest path, a strongly connected path, and a path through a chain of persons only is to be output preferentially. The server device 12 preferentially outputs the specified path out of the shortest path, a strongly connected path, and a path through a chain of persons only, in response to the received input of specification. As a result, the server device 12 may preferentially output a path having a possibility of introducing a person to contact, according to the condition of the specified path.

The server device 12 receives a specification for prioritizing the time up to a person to contact. When receiving the specification for prioritizing the time up to the person to contact, the server device 12 preferentially outputs the shortest path. As a result, the server device 12 may preferentially output a path having a possibility of introducing a person to contact in a short time.

The server device 12 starts a call to a calling destination corresponding to a person in response to a specification of a display corresponding to the person included in the output path or a specification of a display associated with the display corresponding to the person. As a result, the server device 12 may provide an environment in which a call may be easily made to persons and companies which is on a path of an introduction to a person to contact.

The server device 12 executes a search for a traveling route to a location corresponding to a person or a company and outputs a search result in response to a specification of a display corresponding to a person included in the output path or a specification of a display associated with the display corresponding to a person. As a result, the server device 12 may provide a traffic route for visiting the specified person and company.

### Example 2

For example, in the above example, the case of supporting the sales operations for acquiring a new customer by the user as a salesperson in charge of corporations in an insurance company is described as an example. However, the user is not limited to the salesperson in charge of corporations in the insurance company, but may also be various users who operate the sales. The sales operation is not limited to the sales operation of the insurance company, but may be a sales operation for acquiring a new customer in a business type other than the insurance company.

In the above example, the case where the relation information 30 is stored in the storage unit 21 has been described as an example. However, the example is not limited to the case. For example, the relation information 30 may be stored in an external storage device coupled to the network N, and the server device 12 may access the external storage device and read the information from the relation information 30. For example, the server device 12 collects information on relationships between persons, between companies, and between persons and companies from the Internet, a server of an information providing service provider, and the like, periodically or at the timing of receiving an input of information for identifying a person to contact. Based on the collected information, the identification unit 42 may identify a path leading from the logged-in user to a person to contact through a chain of persons having a relationship.

In the above example, the case where the contact support processing is executed by the server device 12 has been described as an example. However, the example is not limited to the case. For example, various programs and data may be downloaded from the server device 12 to the user terminal 11, and the user terminal 11 may execute the contact support processing. In this case, the user terminal 11 corresponds to a contact support device.

In the example described above, the degree of relationship between the objects and the case of correcting familiarity based on the power relation have been described as an example. However, the example is not limited the cases. For example, familiarity may be corrected according to the actual result as to whether or not the contact has been approached. For example, the reception unit 41 receives information of the actual result on the success or failure of the approach to a contact target. For example, the reception unit 41 receives an input of a path for which the approach has been successful to a contact target. The control unit 22 may perform correction to raise the familiarity stored in the relation information 30 for the objects constituting the path for which the approach has been successful. When an introduction is refused by any object in the path, the control unit 22 may perform correction to lower the familiarity of the relationship for which the introduction is refused.

For each object, the control unit 22 may count the actual result of success or failure of an introduction and store the actual result in the storage unit 21. When a plurality of paths are identified, the output unit 43 may preferentially output a path so that the path passes through an object having an actual result of many successful introductions. The identification unit 42 may identify a path so that the path passes through an object having an actual result of many successful introductions.

Depending on an introducer, an initial visit of the salesperson to a contact target may progress smoothly or may be affected. For example, in the case of an introduction from a person having high familiarity with a contact target, the contact target tends to have a smooth initial visit with a salesperson. Therefore, the identification unit 42 may identify a path so that an object having the high familiarity with a contact target is located immediately before the contact target. For example, the identification unit 42 searches the relation information 30 for an object whose familiarity to a contact target is equal to or more than a predetermined threshold value (for example, 80) as an approaching object to the contact target, and searches for a path leading to the approaching object. The identification unit 42 may add a chain from the approaching object of the searched path to a contact target and identify a path leading to the contact target.

In sales activities, it is important to get an introduction to contact targets. Therefore, the identification unit 42 may identify a path so that an object having an actual result of many successful introductions becomes immediately before the contact target.

In the above example, the case where an input of information for identifying a person to contact is received from the user is described as an example. However, the example is not limited to the case. For example, the control unit 22 searches for candidates for sales targets within an area that the salesperson is in charge of, or an area handled by the business office to which the salesperson belongs, based on various information obtained from various homepages or servers of information providing service providers. For example, the control unit 22 searches for candidates for sales targets for which information such as a new company or a relocated company has been collected in a predetermined period (for example, within 6 months from the present time), as candidates for sales targets. When a candidate for a sales target is searched, the control unit 22 may use each candidate for each sales target as a contact target, and identify and output a path leading to the contact target.

The constituent elements of each of the devices illustrated in the drawings are functionally conceptual and do not necessarily have to be physically configured as illustrated. That is, the specific state of distribution or integration of each device is not limited to that illustrated in the drawings, and all or a part of the device may be configured by being functionally or physically distributed or integrated into additional units according to various workloads and usage situations. For example, the respective processing units of the display control unit 40, the reception unit 41, the identification unit 42, the output unit 43, the call control unit 44, and the search unit 45 may be integrated or divided appropriately. Each processing unit may be distributed and executed by a plurality of server devices. All or random part of each processing unit may be realized by a CPU and a program analyzed and executed by the CPU or may be realized as hardware by a wired logic.

Contact Support Program

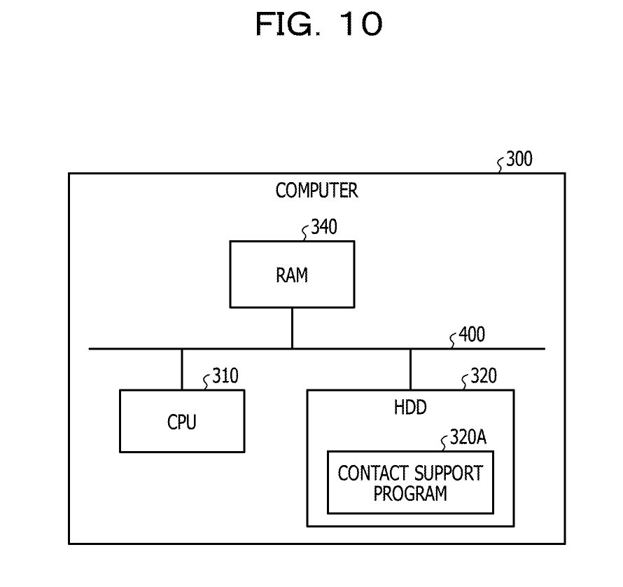

The various kinds of processing described in the above examples may also be realized by executing a prepared program on a computer system such as a personal computer or a workstation. Therefore, in the following, an exemplary computer system that executes a program having the same function as the above embodiment will be described. FIG. 10 illustrates an exemplary computer that executes a contact support program.

As illustrated in FIG. 10, a computer 300 includes a CPU 310, a hard disk drive (HDD) 320, and a random access memory (RAM) 340. The units 310 to 340 are coupled to each other via a bus 400.

In the HDD 320, a contact support program 320A that exhibits the same function as each processing unit of the server device 12 of the above example is stored in advance. For example, the contact support program 320A that exhibits the same functions as the display control unit 40, the reception unit 41, the identification unit 42, the output unit 43, the call control unit 44, and the search unit 45 of the above example is stored. The contact support program 320A may be appropriately separated.

The HDD 320 stores various data. For example, the HDD 320 stores the OS and various data.

The CPU 310 reads the contact support program 320A from the HDD 320 and executes the program, and executes operations similar to those of the display control unit 40, the reception unit 41, the identification unit 42, the output unit 43, the call control unit 44, and the search unit 45 of the example. That is, the contact support program 320A executes the same operations as the display control unit 40, the reception unit 41, the identification unit 42, the output unit 43, the call control unit 44, and the search unit 45 of the example.

The above-described contact support program 320A is not necessarily stored in the HDD 320 from the beginning. For example, the program is stored in “portable physical medium” such as a flexible disk (FD), a compact disk read only memory (CD-ROM), a digital versatile disk (DVD), a magneto-optic disk, and an IC card inserted in the computer 300. The computer 300 may read and execute the program from the medium.

Furthermore, the program is stored in “another computer (or server)” or the like coupled to the computer 300 via a public line, the Internet, a LAN, a WAN, or the like. The computer 300 may read and execute the program from the computer.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A non-transitory computer-readable recording medium recording a contact support program causing a computer to execute a process, the process comprising:
receiving an input of information to identify a person to contact for a first user;
performing at least one of referring to a storage that stores relationships between persons, between companies, or between persons and companies and collecting information on the relationships between the persons, between the companies, or between the persons and the companies from a network;
identifying a path which leads from the first user to the person to contact through a chain of persons having a relationship or a chain of mixed persons and companies having a relationship; and
outputting information on the identified path.

2. The non-transitory computer-readable recording medium according to claim 1, wherein
in the receiving, an input of a specification as to which one of a shortest path, a strongly connected path, and a path through a chain of persons only is to be output preferentially is received, and
in the outputting, a specified path out of the shortest path, the strongly connected path, and the path through the chain of persons only is preferentially output, in response to the input of the specification.

3. The non-transitory computer-readable recording medium according to claim 2, wherein
in the receiving, a specification to prioritize time up to the person to contact is received, and
in the outputting, the shortest path is preferentially output based on the specification to prioritize.

4. The non-transitory computer-readable recording medium according to claim 1, further comprising:
starting, in response to a specification of a display corresponding to a person included in the information on the identified path or a specification of a display associated with the display corresponding to the person, a call to a calling destination corresponding to the person.

5. The non-transitory computer-readable recording medium according to claim 1, further comprising:
executing, in response to a specification of a display corresponding to a person included in the information on the identified path or a specification of a display associated with the display corresponding to the person, a search for a traveling route to a location corresponding to the person; and
outputting a search result.

6. The non-transitory computer-readable recording medium according to claim 1, further comprising:
executing, in response to a specification of a display corresponding to a company included in the information on the identified path or a specification of a display associated with the display corresponding to the company, a search for a traveling route to a location corresponding to the company; and
outputting a search result.

7. A contact support method comprising:
receiving, by a computer, an input of information to identify a person to contact for a first user;
performing at least one of referring to a storage that stores relationships between persons, between companies, or between persons and companies and collecting information on the relationships between the persons, between the companies, or between the persons and the companies from a network;
identifying a path which leads from the first user to the person to contact through a chain of persons having a relationship or a chain of mixed persons and companies having a relationship; and
outputting information on the identified path.

8. The contact support method according to claim 7, wherein
in the receiving, an input of a specification as to which one of a shortest path, a strongly connected path, and a path through a chain of persons only is to be output preferentially is received, and
in the outputting, a specified path out of the shortest path, the strongly connected path, and the path through the chain of persons only is preferentially output, in response to the input of the specification.

9. The contact support method according to claim 8, wherein
in the receiving, a specification to prioritize time up to the person to contact is received, and
in the outputting, the shortest path is preferentially output based on the specification to prioritize.

10. The contact support method according to claim 7, further comprising:
starting, in response to a specification of a display corresponding to a person included in the information on the identified path or a specification of a display associated with the display corresponding to the person, a call to a calling destination corresponding to the person.

11. The contact support method according to claim 7, further comprising:
executing, in response to a specification of a display corresponding to a person included in the information on the identified path or a specification of a display associated with the display corresponding to the person, a search for a traveling route to a location corresponding to the person; and
outputting a search result.

12. The contact support method according to claim 7, further comprising:
executing, in response to a specification of a display corresponding to a company included in the information on the identified path or a specification of a display associated with the display corresponding to the company, a search for a traveling route to a location corresponding to the company; and
outputting a search result.

13. An information processing apparatus comprising:
a memory; and
a processor coupled to the memory and configured to perform operations of:
receiving an input of information to identify a person to contact for a first user;
performing at least one of referring to a storage that stores relationships between persons, between companies, or between persons and companies and collecting information on the relationships between the persons, between the companies, or between the persons and the companies from a network;
identifying a path which leads from the first user to the person to contact through a chain of persons having a relationship or a chain of mixed persons and companies having a relationship; and
outputting information on the identified path.

14. The information processing apparatus according to claim 13, wherein
the processor is configured to:
receive, in the receiving, an input of a specification as to which one of a shortest path, a strongly connected path, and a path through a chain of persons only is to be output preferentially; and
output preferentially, in the outputting, a specified path out of the shortest path, the strongly connected path, and the path through the chain of persons only in response to the input of the specification.

15. The information processing apparatus according to claim 14, wherein
the processor is configured to:
receive, in the receiving, a specification to prioritize time up to the person to contact; and
output preferentially, in the outputting, the shortest path based on the specification to prioritize.

16. The information processing apparatus according to claim 13, wherein
the processor is configured to start, in response to a specification of a display corresponding to a person included in the information on the identified path or a specification of a display associated with the display corresponding to the person, a call to a calling destination corresponding to the person.

17. The information processing apparatus according to claim 13, wherein
the processor is configured to:
execute, in response to a specification of a display corresponding to a person included in the information on the identified path or a specification of a display associated with the display corresponding to the person, a search for a traveling route to a location corresponding to the person; and
output a search result.

18. The information processing apparatus according to claim 13, wherein:
the processor is configured to:
execute, in response to a specification of a display corresponding to a company included in the information on the identified path or a specification of a display associated with the display corresponding to the company, a search for a traveling route to a location corresponding to the company; and
output a search result.
